(19) United States
(12) Patent Application Publication
(10) Pub. No.: US 2004/0252977 A1
(43) Pub. Date: Dec. 16, 2004

(54) Still image extraction from video streams

(75) Inventors: Talal A. Batrouny, Sammamish, WA (US); Terje K. Backman, Carnation, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMOND, WA (US)

(21) Appl. No.: 10/462,519

(22) Filed: Jun. 16, 2003

(51) Int. Cl. H04N 5/76

(52) U.S. Cl. 386/96; 386/98

(57) ABSTRACT

Described herein is an implementation that identifies one or more video-still segments that are interleaved with motion video segments in a video-stream. The implementation extracts and enhances a still image from a video-still segment and exacts its associated audio. This abstract itself is not intended to limit the scope of this patent. The scope of the present invention is pointed out in the appending claims.

### TECHNICAL FIELD

This invention generally relates to a multimedia technology.

### BACKGROUND

Video equipment, like camcorders, generates a video stream. Such a video stream contains a series of pictures (i.e., “frames”) taken over time and typically at a defined frequency (e.g., 25 frames per second). When presented at the defined frequency, the video stream displays moving pictures and its associated audio recorded along with the pictures.

These video streams may be stored onto standard analog formats (such as standard VHS, VHS-C, Super VHS, Super VHS-C, 8 mm, or Hi-8), onto standard digital formats (such as miniDV, Digital8, DVD, or memory cards), or onto other storage devices (e.g., hard drives, floppy disks, flash memory, CD-ROMs, etc.) or formats (e.g., MPEG).

Although video cameras are typically designed to capture moving pictures along with their associated audio, some have a feature that store a repeating still picture on successive frames to effectively produce a still image that lasts for a period of time (e.g., several seconds long) in the video stream. This produces “video-still” segments, as it is called herein.

While capturing the video-stills, these cameras also typically capture the environmental sounds and they are recorded with the video-still. These environmental sounds may be the narration by the cameraperson.

This still-video capture feature of a video camera may be called the “snap shot” mode. Canon ZR70, Panasonic PV-DV601D, and Sony VX2000 are examples of camcorders that have this feature.

Although a camera may capture still images as still-video, there is no existing mechanism for effectively and automatically extracting these video-stills from the video streams and producing a still image from the extracted video-stills.

### SUMMARY

An implementation is described herein that identifies one or more video-still segments that are interleaved with motion video segments in a video-stream. The implementation extracts and enhances a still image from a video-still segment and exacts its associated audio.

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a block diagram of a system in accordance with an implementation described herein.

FIG. 2 is a flow diagram showing a methodological implementation described herein.

FIG. 3 is an example of a computing operating environment capable of (wholly or partially) implementing at least one embodiment described herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well-known features are omitted or simplified to clarify the description of the exemplary implementations of the present invention, and thereby, to better explain the present invention. Furthermore, for ease of understanding, certain method steps are delineated as separate steps; however, these separately delineated steps should not be construed as necessarily order dependent in their performance.

The following description sets forth one or more exemplary implementations of a Still Image Extraction from Video Streams that incorporate elements recited in the appended claims. These implementations are described with specificity in order to meet statutory written description, enablement, and best-mode requirements. However, the description itself is not intended to limit the scope of this patent.

The inventors intend these exemplary implementations to be examples. The inventors do not intend these exemplary implementations to limit the scope of the claimed present invention; rather, the inventors have contemplated that the claimed present invention might also be embodied and implemented in other ways, in conjunction with other present or future technologies.

An example of an embodiment of a Still Image Extraction from Video Streams may be referred to as an “exemplary video-still extractor.”

Introduction

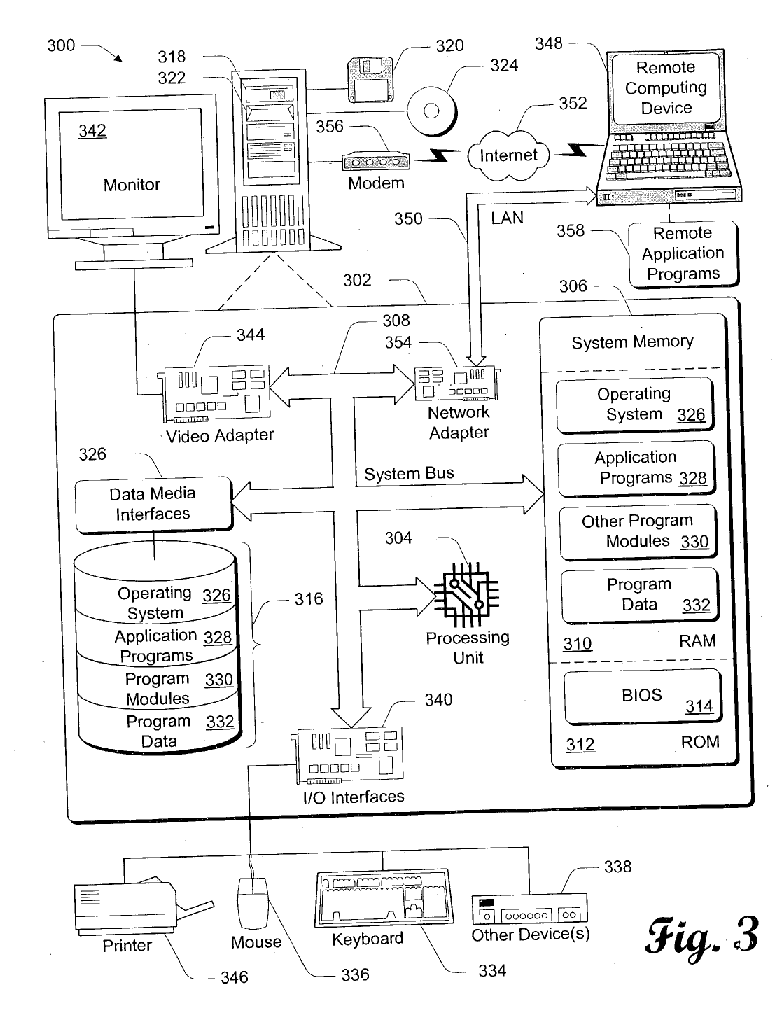

The one or more exemplary implementations, described herein, of the present claimed invention may be implemented (in whole or in part) by a video-still extraction system 100 and/or as part of a computing environment like that shown in FIG. 3.

Although video cameras are typically designed to capture moving pictures along with their associated audio, some have a feature that store a repeating still picture on successive frames to effectively produce a still image that lasts for a period of time (e.g., several seconds long) in the video stream. This produces “video-still” segments, as it is called herein.

However, when such a video stream is captured by a computer, no distinction is made between the typical motion video segments and the video-still segments. It is all viewed and handled as motion video.

The exemplary video-still extractor automatically identifies one or more video-still segments that are interleaved with motion video segments in a video-stream. It extracts and enhances a still image from a video-still segment and exacts its associated audio. The exemplary video-still extractor stores the extracted image as a single image (rather than a series of successive frames of a video-stream) with its associated audio.

Exemplary Video-Still Extractor

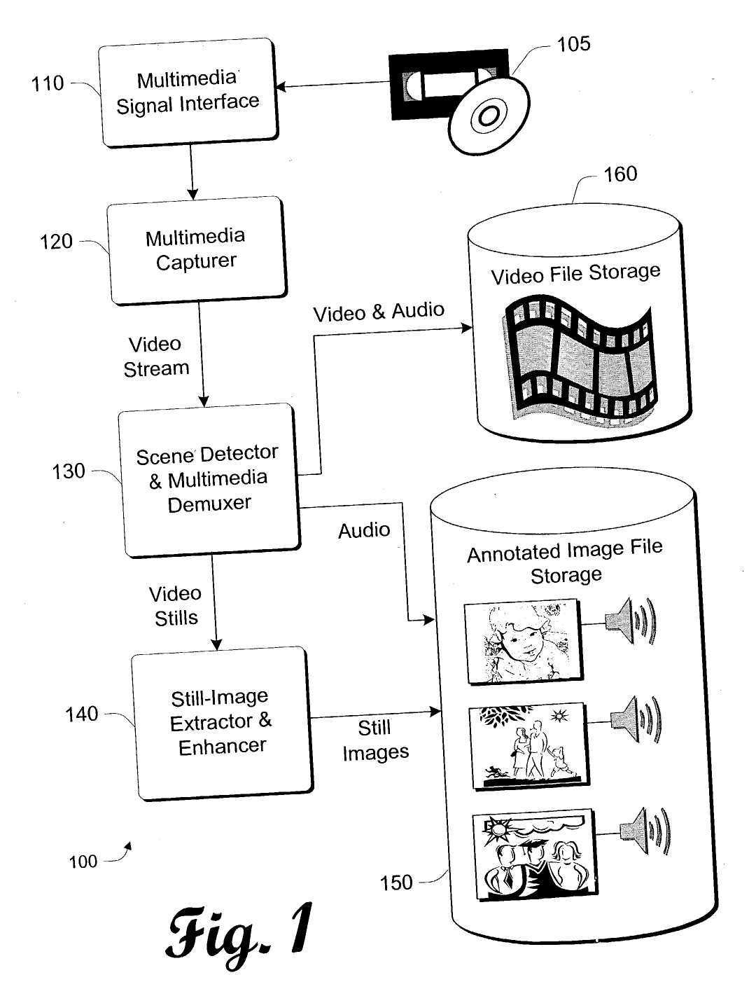

FIG. 1 is a block diagram illustrating the video-still extraction system 100 and its operation. Many of the components of the video-still extraction system 100, described herein, may be implemented in software, hardware, or a combination thereof.

The tape and disk represents a video source 105. A video source has a video stream stored therein in analog or digital formats. Examples of standard analog formats include standard VHS, VHS-C, Super VHS, Super VHS-C, 8 mm, or Hi-8 tapes. Examples of standard digital formats includes miniDV, Digital8 tape, DVD disks, or memory cards, hard drives, floppy disks, flash memory, CD-ROMs, etc. A video source may be a live feed from a video camera itself.

Regardless of the video equipment used or the specific format in which the video source 105 is stored (or perhaps provided live), the video from the video source possibly include “video-stills” and those still are possibly interleaved with motion video.

A multimedia signal interface 110 is the input device for the video-still extraction system 100. It receives the video source 105. For example, if the video source 105 is a VHS tape, the tape may be played in a typically VHS player and standard video cables and connections connect the interface 110 to the VHS player. Such standard cables and connections may be composite video, S-video, or the like.

The interface 110 is coupled to a multimedia capturer 120 and passes on the incoming multimedia signal from the video source to the capturer 120. The interface 110 may be an external device and the multimedia capturer 120 may be on a host computer. In this situation, the interface 110 may transfer to the capturer 120 on the host computer via high speed communications link (e.g., IEEE-1394, USB2, etc.).

The multimedia 120 performs traditional video capturing-thus it renders the incoming signal into video and audio content with a digital format. This produces a video stream. The particular digital format may be any format that is suitable to this purpose.

The capturer 120 may a software program module (such as a device driver) associated with the interface 110. Alternatively, the interface 110 and capturer 120 may be combined into an integral unit for doing the interfacing and capturing together.

The video stream from the capturer 120 is passed on to a scene detector & multimedia demuxer 130. This device detects “scenes” (e.g., video-still segments) and de-multiplexes the detected video-still segments of the video stream. De-multiplexing is the separation of the audio from the video content of the video stream.

The motion-video segments of the video stream may be discarded. While the motion-video segments are not processed by the video-still extraction system 100 (other than to extract them), the user might wish to use them in other projects. Therefore, the scene detector & multimedia demuxer 130 may store the motion-video segments stored in the video file storage 160 for later use.

The scene detector & multimedia demuxer 130 detects and separates the video-still segments (and its associated audio content) from the video-motion segments of the video stream. A video-still segment may be defined as set of contiguous frames having the same unmoving image. It may also have customizable minimum length (such as 2 seconds).

The scene detector & multimedia demuxer 130 also extracts any accompanying audio associated with the video-still segments. The edges of this audio are defined by the edges of its associated video-still segment.

The accompanying audio is delivered to annotated image file storage 150 to be stored with the image resulting from its associated video-still segment. The video-still segments are sent to a still-image extractor & enhancer 140 for it to extract a single image from each video-still segment and enhance that image.

The existence of a video-still segment may be determined by comparing 11 successive frames of the video stream to each other. A collection of contiguous identical frames may define a video-still segment. Such comparisons may be multimodal.

The “edges” of video-still segments may be detected via numerous ways known to those of ordinary skill in the art. There may be obvious harsh breaks that define the edges of the “still” scenes.

Other approaches to define video-still segments may be statistically based. For example, it may detect the magnitude of inter-frame deltas and the standard deviation of each frame from the computed average frame. It may, for example, detect gross changes in video and/or audio content.

The “still” scenes are processed (as discussed above) and the resulting image is written onto a storage medium (such as a hard drive, floppy disk, flash memory, etc.). It may use a number or naming scheme to identify the images produced. The resulting images may be stored as individual files or as part of collection of images such as an image database.

Regardless of where the images are stored, the still-image extractor & enhancer 140 saves any timestamps associated with the images such that the still images and the associated captured audio clips may be temporally correlated.

The still-image extractor & enhancer 140 receives the video-still segments from the scene detector & multimedia demuxer 130. For each video-still segment, it extracts a single digital image and enhances that image.

The still-image extractor & enhancer 140 enhances the resulting image quality by processing the set of captured video fields in a still-video segment to minimize video artifacts.

Those who are of ordinary skill in the art are aware of techniques to remove noise and enhance image quality when given a continuous set of effectively multiple exposures of the same “scene.” The image in this set may be processed to eliminate noise. They may be stacked to generate a high quality image as a result.

Although they may look identical, each frame of a video-still segment is slightly different because they are likely to contain noise. Using known image-processing techniques (such as filtering and averaging), the image noise may be removed and thus the resulting image enhanced.

One technique is called oversampling. That is where a sequence of captured video frames is blended together into a single image. It is primarily useful to remove random noise. Since the noise is different in every frame, blending many frames together acts to cancel out the noise.

Furthermore, the still-image extractor & enhancer 140 may use other known techniques to improve images captured from video streams. The image may also be composed of odd-even video fields which may be de-interlaced into a progressive image using numerous ways known to those of ordinary skill in the art.

The still-image extractor & enhancer 140 stores the enhanced image from each video-still segment as a digital image file (e.g., formatted in jpeg) on the annotated image file storage 150. Stored with each image file is the audio content extracted from the same video-still segment as the image was extracted.

Therefore, the audio captured during the duration of each video-still segment is stored with the image resulting from that same video-still segment. This audio may be the narration of the video-still segment. Both the audio and the still image data can have associated matching timestamps for correlating the images.

Methodological Implementation of the Exemplary Video-Still Extractor

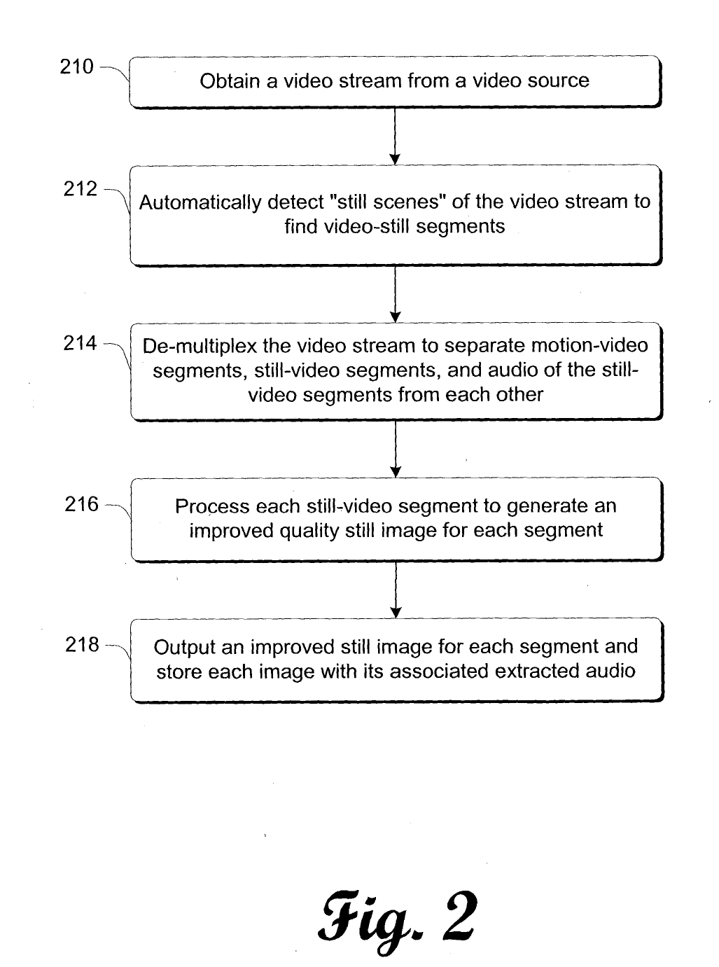

FIG. 2 shows a methodological implementation of the exemplary video-still extractor performed by the video-still extraction system 100 (or some portion thereof). This methodological implementation may be performed in software, hardware, or a combination thereof.

At 210 of FIG. 2, the exemplary video-still extractor obtains the video stream from the video source 105.

At 212 of FIG. 2, the exemplary video-still extractor automatically detects still scenes (i.e., “scene detection”) in incoming video stream to find video-still segments.

At 214 of FIG. 2, it de-multiplexes of normal motion-video segments, still-video segments, and audio of the still-video segments separate streams.

At 216 of FIG. 2, the exemplary video-still extractor processes each still-video segment to generate an improved quality still image for each segment. Its improvements may include enhancing details, increasing resolution, de-interlacing, and reducing the noise.

At 218 of FIG. 2, the exemplary video-still extractor outputs an improved still image for each segment and stores it as an image file (e.g., jpeg) with its associated extracted audio. The audio and still image data may be stored as individual files or as part of a collection of images and audio such as an multimedia database or multiplexed multimedia stream such as an ASF file container, DV file or MPEG audio/video file.

Exemplary Computing System and Environment

FIG. 3 illustrates an example of a suitable computing environment 300 within which an exemplary video-still extractor, as described herein, may be implemented (either fully or partially). The computing environment 300 may be utilized in the computer and network architectures described herein.

The exemplary computing environment 300 is only one example of a computing environment and is not intended to suggest any limitation as to the scope of use or functionality of the computer and network architectures. Neither should the computing environment 300 be interpreted as having any dependency or requirement relating to any one or combination of components illustrated in the exemplary computing environment 300.

The exemplary video-still extractor may be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary video-still extractor may be described in the general context of computer-executable instructions, such as program modules, being executed by a computer. Generally, program modules include routines, programs, objects, components, data structures, etc. that perform particular tasks or implement particular abstract data types. The exemplary video-still extractor may also be practiced in distributed computing environments where tasks are performed by remote processing devices that are linked through a communications network. In a distributed computing environment, program modules may be located in both local and remote computer storage media including memory storage devices.

The computing environment 300 includes a general-purpose computing device in the form of a computer 302. The components of computer 302 may include, but are not limited to, one or more processors or processing units 304, a system memory 306, and a system bus 308 that couples various system components, including the processor 304, to the system memory 306.

The system bus 308 represents one or more of any of several types of bus structures, including a memory bus or memory controller, a peripheral bus, an accelerated graphics port, and a processor or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 302 typically includes a variety of computer-readable media. Such media may be any available media that is accessible by computer 302 and includes both volatile and non-volatile media, removable and non-removable media.

The system memory 306 includes computer-readable media in the form of volatile memory, such as random access memory (RAM) 310, and/or non-volatile memory, such as read only memory (ROM) 312. A basic input/output system (BIOS) 314, containing the basic routines that help to transfer information between elements within computer 302, such as during start-up, is stored in ROM 312. RAM 310 typically contains data and/or program modules that are immediately accessible to and/or presently operated on by the processing unit 304.

Computer 302 may also include other removable/non-removable, volatile/non-volatile computer storage media. By way of example, FIG. 3 illustrates a hard disk drive 316 for reading from and writing to a non-removable, non-volatile magnetic media (not shown), a magnetic disk drive 318 for reading from and writing to a removable, non-volatile magnetic disk 320 (e.g., a “floppy disk”), and an optical disk drive 322 for reading from and/or writing to a removable, non-volatile optical disk 324 such as a CD-ROM, DVD-ROM, or other optical media. The hard disk drive 316, magnetic disk drive 318, and optical disk drive 322 are each connected to the system bus 308 by one or more data media interfaces 326. Alternatively, the hard disk drive 316, magnetic disk drive 318, and optical disk drive 322 may be connected to the system bus 308 by one or more interfaces (not shown).

The disk drives and their associated computer-readable media provide non-volatile storage of computer readable instructions, data structures, program modules, and other data for computer 302. Although the example illustrates a hard disk 316, a removable magnetic disk 320, and a removable optical disk 324, it is to be appreciated that other types of computer-readable media, which may store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, may also be utilized to implement the exemplary computing system and environment.

Any number of program modules may be stored on the hard disk 316, magnetic disk 320, optical disk 324, ROM 312, and/or RAM 310, including by way of example, an operating system 326, one or more application programs 328, other program modules 330, and program data 332.

A user may enter commands and information into computer 302 via input devices such as a keyboard 334 and a pointing device 336 (e.g., a “mouse”). Other input devices 338 (not shown specifically) may include a microphone, joystick, game pad, satellite dish, serial port, scanner, and/or the like. These and other input devices are connected to the processing unit 304 via input/output interfaces 340 that are coupled to the system bus 308, but may be connected by other interface and bus structures, such as a parallel port, game port, or a universal serial bus (USB).

A monitor 342 or other type of display device may also be connected to the system bus 308 via an interface, such as a video adapter 344. In addition to the monitor 342, other output peripheral devices may include components, such as speakers (not shown) and a printer 346, which may be connected to computer 302 via the input/output interfaces 340.

Computer 302 may operate in a networked environment using logical connections to one or more remote computers, such as a remote computing device 348. By way of example, the remote computing device 348 may be a personal computer, portable computer, a server, a router, a network computer, a peer device or other common network node, and the like. The remote computing device 348 is illustrated as a portable computer that may include many or all of the elements and features described herein, relative to computer 302.

Logical connections between computer 302 and the remote computer 348 are depicted as a local area network (LAN) 350 and a general wide area network (WAN) 352. Such networking environments are commonplace in offices, enterprise-wide computer networks, intranets, and the Internet.

When implemented in a LAN networking environment, the computer 302 is connected to a local network 350 via a network interface or adapter 354. When implemented in a WAN networking environment, the computer 302 typically includes a modem 356 or other means for establishing communications over the wide network 352. The modem 356, which may be internal or external to computer 302, may be connected to the system bus 308 via the input/output interfaces 340 or other appropriate mechanisms. It is to be appreciated that the illustrated network connections are exemplary and that other means of establishing communication link(s) between the computers 302 and 348 may be employed.

In a networked environment, such as that illustrated with computing environment 300, program modules depicted relative to the computer 302, or portions thereof, may be stored in a remote memory storage device. By way of example, remote application programs 358 reside on a memory device of remote computer 348. For purposes of illustration, application programs and other executable program components, such as the operating system, are illustrated herein as discrete blocks, although it is recognized that such programs and components reside at various times in different storage components of the computing device 302, and are executed by the data processor(s) of the computer.

Computer-Executable Instructions

An implementation of an exemplary video-still extractor may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Exemplary Operating Environment

FIG. 3 illustrates an example of a suitable operating environment 300 in which an exemplary video-still extractor may be implemented. Specifically, the exemplary video-still extractor(s) described herein may be implemented (wholly or in part) by any program modules 328-330 and/or operating system 326 in FIG. 3 or a portion thereof.

The operating environment is only an example of a suitable operating environment and is not intended to suggest any limitation as to the scope or use of functionality of the exemplary video-still extractor(s) described herein. Other well known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipments, general- and special-purpose appliances, application-specific integrated circuits (ASICs), network PCs, minicomputers, mainframe computers, distributed computing environments that include any of the above systems or devices, and the like.

Computer-Readable Media

An implementation of an exemplary video-still extractor may be stored on or transmitted across some form of computer-readable media. Computer-readable media may be any available media that may be accessed by a computer. By way of example, computer-readable media may comprise, but is not limited to, “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embodies computer-readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, communication media may comprise, but is not to limited to, wired media such as a wired network or direct-wired connection, and wireless media such as acoustic, RF, infrared, and other wireless media. Combinations of any of the above are also included within the scope of computer-readable media.

### CONCLUSION

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-readable medium having a program module with computer-executable instructions that, when executed by a computer, performs a method comprising:
obtaining a video stream;
automatically detecting one or more video-still segments of the video stream, where each frame of a video-still segment contains substantially identical images;
de-multiplexing the video stream, thereby separating one or more motion-ii video segments, one or more still-video segments, and associated audio of each of the still-video segments;
extracting a still image from one of the still-video segment;
associating demuxed audio with the extracted still image, that demuxed audio was associated with the still-video segment from which the still image was extracted.

2. A medium as recited in claim 1, wherein the method further comprises enhancing the image quality of the still image.

3. A medium as recited in claim 1, wherein the method further comprises outputting the still image with its associated audio.

4. A medium as recited in claim 1, wherein the method further comprises storing the still image with its associated audio on a computer-readable storage medium.

5. A medium as recited in claim 1, wherein the method further comprises separating one or more motion-video segments and storing the motion-video segments with its associated audio on a computer-readable storage medium.

6. An operating system comprising a medium as recited in claim 1.

7. A computing device comprising:
an input device for receiving a video stream;
a medium as recited in claim 1.

8. A computer-readable medium having a program module with computer-executable instructions that, when executed by a computer, performs a method comprising:
detecting one or more video-still segments of a video stream, where each frame of a video-still segment contains substantially identical images;
separating the one or more still-video segments and from its associated audio of the video stream;
extracting a still image from one of the still-video segments.

9. A medium as recited in claim 8, wherein the method further comprises associating audio with the extracted still image, this audio being the separated audio that was associated with the still-video segment from which the still image was extracted.

10. A medium as recited in claim 8, wherein the method further comprises:
associating audio with the still image, this audio being the separated audio that was associated with the still-video segment from which the still image was generated;
outputting the still image with its associated audio.

11. A medium as recited in claim 8, wherein the method further comprises storing the still image with its associated audio on a computer-readable storage medium.

12. A medium as recited in claim 8, wherein the method further comprises enhancing the image quality of the still image.

13. A medium as recited in claim 8, wherein the method further comprises enhancing the image quality of the still image, wherein such enhancement is selected from a group consisting increasing resolution, de-interlacing, and noise reduction.

14. A medium as recited in claim 8, wherein the detecting, separating, and extracting are performed without interactive human input.

15. An operating system comprising a medium as recited in claim 8.

16. A computing device comprising:
an input device for receiving a video stream;
a medium as recited in claim 8.

17. A method comprising:
detecting one or more video-still segments of a video stream, where each frame of a video-still segment contains substantially identical images;
separating the one or more still-video segments and from its associated audio of the video stream;
extracting a still image from one of the still-video segments.

18. A method as recited in claim 17 further comprising associating audio with the extracted still image, this audio being the separated audio that was associated with the still-video segment from which the still image was extracted.

19. A method as recited in claim 17 further comprising:
associating audio with the still image, this audio being the separated audio that was associated with the still-video segment from which the still image was generated;
outputting the still image with its associated audio.

20. A method as recited in claim 17 further comprising storing the still image with its associated audio on a computer-readable, storage medium.

21. A method as recited in claim 17 further comprising enhancing the image quality of the still image.

22. A method as recited in claim 17, wherein the detecting, separating, and extracting are performed without interactive human input.

23. A computer comprising one or more computer-readable media having computer-executable instructions that, when executed by the computer, perform the method as recited in claim 17.

24. A system facilitating extraction of still images from video streams, the system comprising:
a scene detector configured to detect one or more video-still segments of a it video stream, where each frame of a video-still segment contains substantially identical images;
a demultiplexer configured to separate the one or more still-video segments and from its associated audio of the video stream;
a still-image extractor configured to extract a still image from one of the still-video segments.

25. A system as recited in claim 24, wherein the still-image extractor is further configured to associate audio with the extracted still image, this audio being the separated audio that was associated with the still-video segment from which the still image was extracted.

26. A system as recited in claim 24 further comprising a computer-readable storage medium, wherein the still-image extractor is further configured to associate audio with the extracted still image, this audio being the separated audio that was associated with the still-video segment from which the still image was extracted and to output the extracted still image with its associated audio.

27. A system as recited in claim 24, wherein the still-image extractor is further configured to enhance the image quality of the still image.
